(19) United States
(12) Patent Application Publication
(10) Pub. No.: US 2024/0205014 A1
(43) Pub. Date: Jun. 20, 2024

(54) METHOD AND SYSTEM FOR SECURE CONFIDENTIAL DIGITAL CONTENT EXCHANGE

(71) Applicant: ALOSYS COMMUNICATIONS S.R.L., Rome (IT)

(72) Inventors: Eugenio PIGNATELLI, Rome (IT); Giovanni Battista PIGNATELLI, Rome (IT)

(73) Assignee: ALOSYS COMMUNICATIONS S.R.L., Rome (IT)

(21) Appl. No.: 18/555,602

(22) PCT Filed: Apr. 22, 2022
(86) PCT No.: PCT/IB2022/053773

§ 371 Date: Oct. 16, 2023

(30) Foreign Application Priority Data
Apr. 22, 2021 (IT) 102021000010241

(51) Int. Cl. H04L 9/32

(52) U.S. Cl. CPC H04L 9/3231

(57) ABSTRACT

Computer implemented method of exchanging digital contents among a plurality of users registered in a sharing association comprising the following steps: A. on at least one device of each user of said sharing association, generate, associate and store: a personal univocal code of the user under consideration dependent on one or more biometric features; B. on said at least one device of a sender user M, selecting at least one digital content that forms a transmission payload and further selecting one or more recipient users Di of said sharing association with whom said transmission payload is to be sent; C. encrypting said at least one digital content using said personal univocal code of the sender user M, obtaining an encrypted payload; D. for each one of said one or more recipient users Di, encoding said personal univocal code of the sender user M by means of a public key of the recipient user Di, obtaining a respective encoded personal univocal code of the sender user M; E. building an encrypted file comprising the encrypted payload and a matrix binary file, that includes said encoded personal univocal code of the sender user M for each one of said one or more recipient users Di; F. sending the encrypted file to a device of each one of said one or more recipient users Di; and G. on said at least one device of each one of said one or more recipient users Di who receive the encrypted file, decoding said encoded personal univocal code of the sender user M by means of the private key of the recipient user Di and decrypting the encrypted payload.

The present invention relates to a computer implemented method of exchanging digital contents which allows, in a secure, confidential, simple, efficient and reliable way, to ensure that one or more digital contents sent by a sender are accessible only to one or more recipients selected by the sender ensuring their integrity and authenticity, as well as non-repudiation, since the personal identity of sender and recipients is involved in the techniques of encryption and decryption of the digital contents performed by the method; also, in some embodiments the computer implemented method according to the invention allows in a secure, simple, efficient and reliable way to ensure that accessibility is also reserved for contents stored in centralised environments, such as servers or cloud, which are uniquely controllable by the sender.

The present invention also relates to a digital content exchange system configured to perform such method and a computer program configured to perform such method.

In the following of the present description and in the claims, computer implemented method means a method that can be executed by any device provided with one or more processing units, such as for example smartphones, mobile phones, tablets, laptops, personal computers (PCs) and servers. Moreover, in the following of the present description and in the claims, digital content means any computer content such as for example text, video, image, photograph, spreadsheet, presentation.

It is known that security in the digital content exchange and access is currently extremely relevant.

By way of example, the digital contents exchanged among the members of an organization and the new services which can be provided in a smart city, as well as in smart-working platforms or in the cloud, imply a criticality in the secure management of confidential communications exchanged among various sources, as well as in the security of the data content stored in a centralised environment such as the cloud and/or one or more centralized servers due to the fact that the system administrator can decode their content. In fact, data communication infrastructures are subject to risks of violation by third parties not authorised to transmit and/or receive and/or access the data exchanged, creating significant cybersecurity and security problems.

In the prior art, some solutions to the data security problem have been developed, often also based on biometric data of the subjects authorised to transmit, receive and access the exchanged data, especially on proprietary and/or specialised devices. By way of example, some of these prior art solutions are disclosed in documents US 2005/021984 A1, US 2018/034813 A1, US 2014/032924 A1, GB 2584455 A, KR 20100123032 A, WO 2010/137047 A1, IT 102014902319728 and U.S. Ser. No. 10/432,401 B2.

However, such solutions suffer from some drawbacks.

In fact, the prior art solutions are generally complex, do not guarantee security of communications, may be not compliant with privacy regulations, and require specific devices which are difficult to update and are also affected by hardware obsolescence.

The object of the present invention is therefore to allow in a secure, confidential, simple, efficient and reliable way, the exchange and possibly the storage of digital contents ensuring their integrity and authenticity, as well as non-repudiation, also allowing to follow the technological evolution of the devices used through remote updates.

It is specific subject-matter of the present invention a computer implemented method of exchanging digital contents among a plurality of users registered in a sharing association, wherein each user of said sharing association is associated to at least one device provided with one or more processing units and with one or more acquiring devices configured to acquire at least one biometric trait, wherein the computer implemented method comprises the following steps:
A. on said at least one device of each user of said sharing association, associating and storing: a personal univocal code of the user under consideration generated by said at least one device of the user under consideration, wherein said personal univocal code of the user under consideration depends on one or more biometric features of identification of the user under consideration deriving from at least one biometric trait of the user under consideration acquired by said one or more acquiring devices, and a public key and a private key of a asymmetric cryptography algorithm corresponding to the user under consideration, wherein the public keys of all the users of said sharing association are accessible by or stored in said at least one device of each user of said sharing association;
B. on at least one device of a sender user M of said sharing association, selecting at least one digital content that forms a transmission payload and further selecting one or more recipient users D; of said sharing association with whom to share said transmission payload;
C. on said at least one device of the sender user M, encrypting said at least one digital content using as a cryptographic key said personal univocal code of the sender user M, obtaining an encrypted payload;
D. on said at least one device of the sender user M, for each one of said one or more recipient users Dᵢ, encoding said personal univocal code of the sender user M through said asymmetric cryptography algorithm by means of said public key of the recipient user Dᵢ, obtaining a respective encoded personal univocal code of the sender user M;
E. on said at least one device of the sender user M, building an encrypted file comprising the encrypted payload and a matrix binaryfile, that includes said encoded personal univocal code of the sender user M for each one of said one or more recipient users Dᵢ;
F. sending the encrypted file from said at least one device of the sender user M to said at least one device of each one of said one or more recipient users Dᵢ; and
G. on said at least one device of each one of said one or more recipient users Dᵢ receiving the encrypted file,
   a) decoding said encoded personal univocal code of the sender user M through said asymmetric cryptography algorithm by means of said private key of the recipient user Dᵢ, and
   b) decrypting the encrypted payload using as a cryptographic key said personal univocal code of the sender user M, obtaining said at least one digital content.

According to another aspect of the invention, said personal univocal code of each user of said sharing association can further depend on one or more user's identification personal data, optionally selected from the group comprising name, surname, email, fiscal code, VAT number, IMEI code, SSAID code and SIM ICCID code, and/or on a PIN code.

According to a further aspect of the invention, said at least one biometric trait can be selected from the group comprising a fingerprint, a face image, a voice print, an image of an iris, a three-dimensional shape of a hand, and an image of a retina.

According to an additional aspect of the invention, in step F, sending the encrypted file from said at least one device of the sender user M to said at least one device of each one of said one or more recipient users Dᵢ can occur by means of an intermediate storage of the encrypted file on at least one storage server, thereby said at least one device of a sender user M stores the encrypted file on said at least one storage server and said at least one device of each one of said one or more recipient users D; accesses said at least one storage server and downloads the encrypted file.

According to another aspect of the invention, in step F, sending the encrypted file from said at least one device of the sender user M can be conditioned on a biometric recognition of the sender user M.

According to a further aspect of the invention, said at least one device can be selected from the group comprising a smartphone, a tablet, a laptop, and a PC.

According to an additional aspect of the invention, in step A, a respective asymmetric cryptography algorithm accessible from or stored in said at least one device of each user of said sharing association can be associated to each user of said sharing association.

According to another aspect of the invention, said at least one device of the sender user M on which step B selects said at least one digital content can be a first device of the sender user M, optionally a PC, provided with a display, and said at least one device of the sender user M on which steps C, D, E, and F are executed can be a second device of the sender user M, optionally a smartphone, provided with a camera, wherein the computer implemented method further comprises, before step B, the following step:
H. displaying an identification code on said display of said first device of the sender user M, optionally a QRCODE, and acquiring said identification code through said camera of said second device of the sender user M to establish a connection on an encrypted communication channel between said first device of the sender user M and said second device of the sender user M,
wherein, in step B, said at least one digital content is transmitted from said first device of the sender user M to said second device of the sender user M.

It is also specific subject-matter of the present invention a system of digital contents exchange configured to exchange digital contents among a plurality of users registered in a sharing association, wherein each user of said sharing association is associated to at least one device provided with one or more processing units and with one or more acquiring devices configured to acquire at least one biometric trait, wherein said at least one device of each user of said sharing association is configured to execute the computer implemented method of exchanging digital contents among a plurality of users registered in a sharing association as previously described.

According to a further aspect of the invention, the system can further comprise at least one central processing device, optionally comprising or consisting in at least one server and/or at least one PC and/or at least one portable device, that is accessible, optionally via web, by a system administrator, and that records information related to one or more sharing associations of users and one or more logs of events related to transmissions of digital contents among users of a sharing association.

According to an additional aspect of the invention, the system can further comprise at least one storage server.

It is another specific subject-matter of the present invention a set of one or more computer programs comprising instructions that, when executed by one or more processing units of a user's device, cause said user's device to execute the computer implemented method of exchanging digital contents among a plurality of users registered in a sharing association as previously described.

It is further specific subject-matter of the present invention a set of one or more computer-readable media having stored thereon the set of one or more computer programs as just described.

The computer implemented method according to the invention advantageously uses a smartphone (or other conventional portable device) as an aid for the encryption of the digital contents to be exchanged and the detection of data, including biometric data, of the smartphone user participating in the digital content exchange. Optionally, the computer implemented method according to the invention can also use the IMEI code (unique identifier of the smartphone assigned by the phone manufacturer) and/or the SSAID code (unique identifier assigned to an Android device) and the ICCID code of the SIM card (i.e. the unique identifier of the SIM card) installed in the smartphone or a Pin code contained in a secret SMS automatically generated by a web console in the cloud, or in PAAS or SAAS) for the encryption of the digital contents and the control of the authorisation of the user using the smartphone. In particular, the user personal data and/or the user biometric data and/or at least one PIN chosen by the user and/or at least one univocal identifier of the smartphone (e.g. the IMEI code and/or the SSAID code) and/or at least one univocal identifier associated with the telephone service (e.g. the ICCID code of the SIM card, or PIN contained in a secret SMS) are used by the computer implemented method according to the invention to allow the secure and confidential sharing of digital contents.

The computer implemented method according to the invention does not require additional apparatuses or devices, besides the smartphone (or other portable device, such as a tablet), to guarantee the secure and confidential sending of digital contents.

The computer implemented method according to the invention allows the transmission of digital contents also from a PC (or a server), so as to be capable to send contents present on the PC (or the server) itself: the security and confidentiality of digital contents is guaranteed by the encryption advantageously carried out through a smartphone (or other portable device).

The advantages offered by the computer implemented method according to the invention are numerous.

First of all, the control of encryption is entirely managed uniquely locally by the user who sends the digital contents and by the user who receives them, thereby no infrastructure is required for data transfer. In other words, the computer implemented method according to the invention implements a specific one-to-one or one-to-many end-to-end transmission technique, and possibly a storage on centralised environments such as cloud or server in SAAS or PAAS.

Also, the computer implemented method according to the invention does not require centralised access points, potentially vulnerable, and does not have public keys to be exchanged centrally. In other words, no data are transits centrally (and in any case non-encrypted digital contents do not transit), but at most only logs of events related to the transmission of digital contents (e.g., date and time of transmission, type of digital contents, such as data or video, and size of the transmitted digital contents).

Furthermore, in the computer implemented method according to the invention, the control of the decryption by the recipient of the digital contents is bound to the sender's will to have the digital contents decrypted only by the recipients who are authorized to do so by the sender. In particular, in the case of the cloud, only the editor can decrypt what is stored in the cloud by the editor himself/herself.

In other words, the computer implemented method of exchanging digital contents allows, in a secure, confidential, simple, efficient and reliable way, to ensure that one or more digital contents sent by a sender are accessible exclusively by one or more recipients selected by the sender ensuring its integrity and authenticity.

The present invention will be now described, for illustrative but not limiting purposes, according to its preferred embodiments, with particular reference to the Figures of the attached drawings, in which:

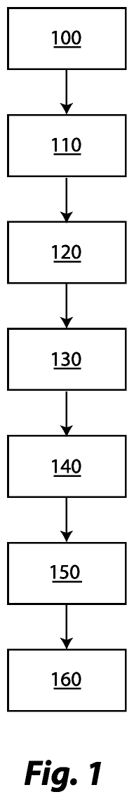

FIG. 1 schematically shows a flow graph of the procedure for registering and associating a user of a preferred embodiment of the computer implemented method of exchanging digital contents according to the invention;

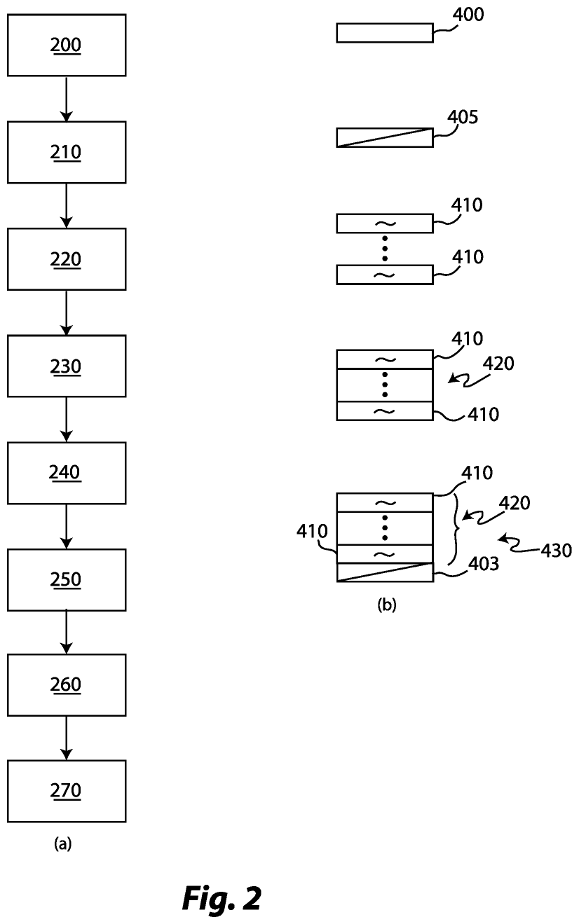

FIG. 2 schematically shows a flow graph of a first procedure of digital content transmission of the preferred embodiment of the computer implemented method of exchanging digital contents according to the invention (FIG. 2a) and a schematic representation of the data processed in the various steps of such procedure (FIG. 2b); and

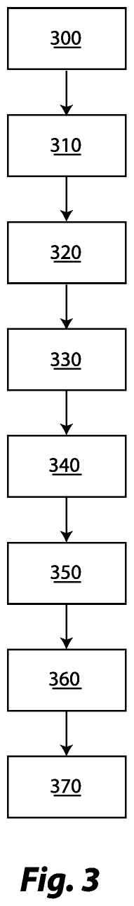

FIG. 3 schematically shows a flow graph of a second procedure of digital content transmission of the preferred embodiment of the computer implemented method of exchanging digital contents according to the invention.

In the Figures identical reference numerals will be used for alike elements.

As previously stated, the computer implemented method of exchanging digital contents, and the related system, according to the invention, advantageously uses a smartphone (or other conventional portable device) as an aid for the encryption of the digital contents to be exchanged and the detection of the data, including biometric data, of the smartphone user participating in the exchange of digital contents. In particular, the computer implemented method according to the invention does not require additional apparatuses or devices, besides the smartphone (or other portable device, such as a tablet), to guarantee the secure and confidential sending of digital contents. Optionally, a central web console, accessible by an administrator of the system according to the invention, maintains the details of associations among users and a log of events related to transmissions of digital contents, but not necessarily the same non-encrypted digital contents, in compliance with the privacy and current legislation.

A preferred embodiment of the computer implemented method of exchanging digital contents according to the invention comprises:
a procedure of user registration and association, through which a user is uniquely identified and registered by means of his/her smartphone and chooses to associate with a plurality, or community, of already registered users;
a first procedure of transmission by an already registered sender user of digital contents present on his/her smartphone by means of the same smartphone to one or more recipient users of his/her community; and
a second procedure of transmission by an already registered sender user of digital contents present on a different device, such as for instance a PC, by means of a connection of the PC (or other device) to his/her smartphone and the use of an identification code, advantageously a QRCODE, to one or more recipient users of his/her community.

With reference to FIG. 1, it can be observed that the procedure of user registration and association preliminarily comprises a first step 100, wherein the user downloads the app comprising instructions which, when executed by at least one processing unit (e.g., one or more microprocessors) of the smartphone, cause the smartphone to execute the computer implemented method of exchanging digital contents according to the invention, and a second step 110 wherein the user starts the app on the smartphone.

Subsequently, the registration and association procedure comprises a third step 120 wherein the user registers in the system according to the invention by entering in the app some user personal identification data (e.g., one or more of the following data: name, surname, email, mobile number, social security number and possibly VAT number), while other user identification data can be entered automatically by the method that acquires them through the operating system of the smartphone (such as IMEI code, SSAID code and ICCID code of the SIM or PIN contained for example in a secret SMS); such user identification data form a first level of identification and security.

Then, in a fourth step 130 of the registration and association procedure, the user selects and enters in the app his/her own PIN code (personal identification code or contained in a secret SMS generated by a centralised web console in the cloud, in PAAS or in SAAS) that forms a second level of identification and security. Advantageously, this PIN code can be provided asynchronously at the registration directly with email or SMS message from at least one central processing device, optionally a server, to which the smartphone connects for the registration and association procedure.

Subsequently, in a fifth step 140 of the registration and association procedure, the user makes the app acquire, by means of the smartphone devices (namely camera and/or microphone), at least one of his/her own biometric traits, e.g. selected from the group comprising a fingerprint, a face image, a voice print, an iris image, from which the app derives one or more user identification biometric features which form a third level of identification and security. It must be noted that in other embodiments of the computer implemented method, and related system, according to the invention, the smartphone can be provided with devices configured to also acquire biometric traits different from those described, such as for example a three-dimensional form of a hand or a retina image, still remaining within the scope of protection of the present invention; to this end, the smartphone could be connected to external acquisition devices and/or could receive one or more user identification biometric features deriving from such acquisitions made by external devices.

Then, in a sixth step 150 of the registration and association procedure, the app uses the user personal identification data and the PIN code entered by the user or contained in a secret SMS and said one or more user identification biometric features, deriving from said at least one biometric trait acquired by the app, to generate a univocal personal code of the user, dependent on such data, which the app then uses for the exchange of digital contents. By way of example, and not by way of limitation, said personal univocal code of the user can be obtained by means of a Boolean operation (e.g., an addition or a subtraction) made on the strings representing the user personal identification data, the PIN code and said one or more biometric features of identification of the user, or by means of an interlacing of portions of such strings with each other, or through any other conventional technique such as using one or more of such strings as seeds of random generation algorithms and possibly carry out Boolean operations or interlacing using randomly generated strings.

It should be noted that other embodiments of the computer implemented method, and related system, according to the invention, can generate said personal univocal code of the user on the basis of only said one or more biometric features of identification of the user, possibly in combination with the user personal identification data or with the PIN code entered by the user or contained in a secret SMS, still remaining within the scope of protection of the present invention.

Finally, in a seventh step 160 of the registration and association procedure, the user selects among the already registered users those with whom he/she wishes to exchange digital contents, thus creating his/her own sharing community. Alternatively or in combination with such selection, the user selects an association of users (who form a community) already registered in the system according to the invention and that is proposed to him by the app; in the case where the user is part of an organisation, he/she is automatically inserted by the app into the organisation community.

With reference to FIG. 2, it can be observed that the first transmission procedure comprises a first step 200 wherein the sender user M selects, through the app, at least one digital content 400, e.g. one or more files, present on his/her smartphone, wherein said at least one digital content 400 forms the so-called payload of the transmission, and further selects one or more recipient users Dᵢ of his/her community with whom said payload is to be shared.

In a second step 210 of the first transmission procedure, said at least one payload digital content 400 is encrypted by using as cryptographic key said personal univocal code of the sender user M, thus obtaining an encrypted payload 405. In particular, for the encryption of said at least one payload digital content 400, any single-key cryptographic algorithm can be used.

Subsequently, in a third step 220 of the first transmission procedure, for each one of said one or more recipient users Dᵢ, said personal univocal code of the sender user M, operating as payload cryptographic key, is encoded through an asymmetric cryptography algorithm by using a public key of the recipient user Dᵢ, obtaining a respective encoded personal univocal code 410. In particular, any asymmetric cryptography algorithm can be used for the encryption of said personal univocal code of the sender user M; optionally, a respective asymmetric cryptography algorithm can be associated to each user when acting as a recipient user.

Then, in a fourth step 230 of the first transmission procedure, a matrix binary file 420 is built that contains a row for each one of said one or more recipient users Dᵢ, containing said encrypted personal univocal code 410 of the sender user M, that is encoded through the public key of the recipient user Dᵢ.

Subsequently, in a fifth step 240, the encrypted payload 405 is appended to the matrix binary file 420 obtained in the fourth step 230, obtaining an encrypted file 430 to be transmitted. Advantageously, the encrypted file 430 can be provided with some heading data, which for example declare the number of lines corresponding to said one or more recipient users Dᵢ.

Then, in a sixth step 250, the sender user M selects the application, among those available on the smartphone, with which the encrypted file 430 is to be sent to said one or more recipient users Dᵢ.

Subsequently, in a seventh step 260, the app requests the sender user M to carry out a biometric recognition to authorise the sending, and the encrypted file 430 is sent upon a positive biometric recognition. Other embodiments of the computer implemented method according to the invention may not have such a seventh step 260, so that the encrypted file 430 is directly sent at the end of the sixth step 250.

Finally, in an eighth step 270, the app residing on the smartphone (or other portable device or PC or server) of each one of said one or more recipient users Dᵢ performs some processing activities on the encrypted file 430 received by the application that the sender user M has selected to send the encrypted file 430, namely:
searching for the row containing said personal univocal code 410 of the sender user M encoded through the public key of the recipient user Dᵢ,
decoding said encoded personal univocal code 410 of the sender user M by using the private key of the recipient user Dᵢ (through the same asymmetric cryptography algorithm used to encode said personal univocal code of the sender user M),
decrypting said encrypted payload 405 by using said personal univocal code of the sender user M (through the same single-key encryption algorithm used to encrypt said at least one payload digital content), thus obtaining at least one payload digital content 400 and thus making it available to the recipient user Dᵢ.

In particular, the app that is on the smartphone (or other portable device or PC or server) of each of said one or more recipient users Dᵢ can make the search for the row containing said encoded personal univocal code 410 of the sender user M through the public key of the recipient user Dᵢ in several ways. By way of example, and not by way of limitation, the univocal personal code of the sender user M could be preceded by a known prefix of few bits (for example included in the possible heading of the encrypted file 430) and the app of each one of said one or more recipient users Dᵢ can decode all the rows containing said encoded personal univocal code 410 of the sender user M, comparing the obtained prefix of bits with the expected one (i.e. with the known prefix of bits) until such bit prefix is equal to the known bit prefix, whereby the app recognises that the decoded row contains said personal univocal code of the sender user M correctly decoded. Alternatively, the rows containing the encoded personal univocal code 410 of the sender user M can be inserted at the head of the encrypted file only after the sender user M has given the command to send the encrypted file 430 in step 250 (or after the app has biometrically recognized the sender user M in step 260) in the same order as the ordered list of said one or more recipient users Dᵢ indicated in the sending application selected in step 250, whereby the app of each one of said one or more recipient users Dᵢ knows which row corresponds to the recipient user Dᵢ.

It must be noted that other embodiments of the computer implemented method according to the invention can provide that the encrypted file 430 is sent (with the application selected in the sixth step 250, possibly upon a positive biometric recognition carried out in the seventh step 260) by the sender user M to said one or more recipient users Dᵢ by means of an intermediate storage of the encrypted file 430 on at least one storage server. In other words, the sender user M stores the encrypted file 430 on said at least one storage server, and each one of said one or more recipient users Dᵢ accesses said at least one storage server to download the encrypted file 430 and execute the eighth step 270 on it. Such sending mode by means of said at least one storage server is particularly advantageous in case of online voting and data sharing among members of a research group.

It must be also noted that the procedure shown in FIG. 1 for registering and associating a user and the first transmission procedure shown in FIG. 2 can be executed by any device provided with a processing unit, such as for instance portable devices (such as tablets and laptops), PCs and servers. In particular, as regards the procedure shown in FIG. 1 for registering and associating a user, this can be executed by any device provided with a processing unit allowing the acquisition and management of biometric data.

Also, the secure and confidential digital content transmission through the computer implemented method of exchanging digital contents according to the invention can also take place by means of a second procedure of transmission based on a connection between the smartphone of the sender user M in which the (main) app of the method according to the invention is installed, that performs the encryption, and a PC in which an auxiliary app is installed that communicates with the (main) app installed in the smartphone, in which PC said at least one digital content that the sending user M wishes to send to one or more recipient users Dᵢ is stored.

With reference to FIG. 3, it can be observed that the second transmission procedure preliminarily comprises a first step 300 wherein the user downloads the auxiliary app through which he/she makes the registration and association as described in steps 120-160 described with reference to FIG. 1, wherein step 120 is executed on the PC while steps 130-160 are executed on the smartphone. In particular, step 120 can be partially executed on the PC, limitedly to the entry of the user personal identification data, while the entry of the other user identification data automatically acquired through the smartphone operating system (such as IMEI code, SSAID code and ICCID code of the SIM, PIN) can be executed on the smartphone. Alternatively, step 120 can be entirely executed on the PC, and in this case the user identification data automatically acquired through the smartphone operating system can be transmitted from the smartphone to the PC.

Once the registration and association have been carried out, in a second step 310, the sender user M opens the auxiliary app on the PC that generates an identification code, advantageously a QRCODE, that is displayed on (at least) one PC screen.

Then, in a third step 320, the sender user M opens the app on the smartphone and makes it acquire the identification code, advantageously a QRCODE, displayed on said (at least one) PC screen, and the smartphone and the PC establish a connection on a secure encrypted communication channel through which smartphone and PC communicate with each other ensuring the security of the information exchanged.

Subsequently, in a fourth step 330, the sender user M selects, through the auxiliary app, one or more recipient users Dᵢ of his/her community with whom such payload is to be shared.

Then, in a fifth step 340, the sender user M selects, through the auxiliary app, at least one digital content, e.g. one or more files, present on his/her PC, wherein said at least one digital content forms the so-called payload of the transmission, to be shared with said one or more recipient users Dᵢ and transmits it to the smartphone that executed its encoding and generates the encrypted file 430 by executing the steps 210, 220, 230 and 240 illustrated with reference to FIG. 2, and the encrypted file 430 is sent from the smartphone to the PC.

Subsequently, in a sixth step 350, the sender user M selects the application, among those available on the PC, with which the encrypted file 430 is to be sent to said one or more recipient users Dᵢ. The transmission can also take place in a block chain manner.

Then, in a seventh step 360, the auxiliary app requires the sender user M for carrying out a biometric recognition to authorise the sending (possibly through the app installed in the smartphone). Other embodiments of the computer implemented method according to the invention may not have such seventh step 360.

Finally, in an eighth step 370, the app that is on the smartphone (or other portable device or PC or server) of each one of said one or more recipient users Dᵢ performs some processing activities on the encrypted file 430 received from the application that the sender user M has selected to send the encrypted file 430, as illustrated for step 270 shown in FIG. 2.

The digital content exchange system configured to execute the computer implemented method according to the invention comprises a plurality of devices provided with processing units, such as for instance portable devices (such as smartphones, tablets and laptops), PCs and servers, each one of them is configured to execute the computer implemented method of exchanging digital contents according to the invention, for the steps of both sending and receiving the digital contents. Optionally, the system can include at least one central processing device, optionally at least one server (optionally accessible in the cloud) and/or at least one PC, that is accessible, possibly also via web, by a system administrator, and that records information related to the associations among users and one or more logs of events related to the transmissions of digital contents, but not necessarily the same non-encrypted digital contents, in compliance with the privacy and current legislation.

The preferred embodiments of this invention have been described and a number of variations have been suggested hereinbefore, but it should be understood that those skilled in the art can make other variations and changes without so departing from the scope of protection thereof, as defined by the attached claims.

1. A computer implemented method of exchanging digital contents among a plurality of users registered in a sharing association, wherein each user of said sharing association is associated to at least one device provided with one or more processing units and with one or more acquiring devices configured to acquire at least one biometric trait, wherein the computer implemented method comprises the following steps:
A. on said at least one device of each user of said sharing association, associating and storing: a personal univocal code of the user under consideration generated by said at least one device of the user under consideration, wherein said personal univocal code of the user under consideration depends on one or more biometric features of identification of the user under consideration deriving from at least one biometric trait of the user under consideration acquired by said one or more acquiring devices, and a public key and a private key of a asymmetric cryptography algorithm corresponding to the user under consideration, wherein the public keys of all the users of said sharing association are accessible by or stored in said at least one device of each user of said sharing association;
B. on at least one device of a sender user of said sharing association, selecting at least one digital content that forms a transmission payload and further selecting one or more recipient users of said sharing association with whom to share said transmission payload;
C. on said at least one device of the sender user, encrypting said at least one digital content using as a cryptographic key said personal univocal code of the sender user M, obtaining an encrypted payload;
D. on said at least one device of the sender user, for each one of said one or more recipient users, encoding said personal univocal code of the sender user through said asymmetric cryptography algorithm by means of said public key of the recipient user, obtaining a respective encoded personal univocal code of the sender user;
E. on said at least one device of the sender user, building an encrypted file comprising the encrypted payload and a matrix binary file, that includes said encoded personal univocal code of the sender user for each one of said one or more recipient users;
F. sending the encrypted file from said at least one device of the sender user to said at least one device of each one of said one or more recipient users; and
G. on said at least one device of each one of said one or more recipient users receiving the encrypted file,
a) decoding said encoded personal univocal code of the sender user through said asymmetric cryptography algorithm by means of said private key of the recipient user, and
b) decrypting the encrypted payload using as a cryptographic key said personal univocal code of the sender user, obtaining said at least one digital content.

2. The computer implemented method according to claim 1, wherein said personal univocal code of each user of said sharing association further depends on one or more user's identification personal data.

3. The computer implemented method according to claim 1, wherein said at least one biometric trait is selected from the group comprising a fingerprint, a face image, a voice print, an image of an iris, a three-dimensional shape of a hand, and an image of a retina.

4. The computer implemented method according to any claim 1, wherein, in step F, sending the encrypted file from said at least one device of the sender user to said at least one device of each one of said one or more recipient users occurs by means of an intermediate storage of the encrypted file on at least one storage server, thereby said at least one device of a sender user stores the encrypted file on said at least one storage server and said at least one device of each one of said one or more recipient users accesses said at least one storage server and downloads the encrypted file.

5. The computer implemented method according to claim 1, wherein, in step F, sending the encrypted file from said at least one device of the sender user is conditioned on a biometric recognition of the sender user.

6. The computer implemented method according to claim 1, wherein said at least one device is selected from the group comprising a smartphone, a tablet, a laptop, and a PC.

7. The computer implemented method according to claim 1, wherein, in step A, a respective asymmetric cryptography algorithm accessible from or stored in said at least one device of each user of said sharing association is associated to each user of said sharing association.

8. The computer implemented method according to claim 1, wherein said at least one device of the sender user on which step B selects said at least one digital content is a first device of the sender user, provided with a display, and said at least one device of the sender user on which steps C, D, E, and F are executed is a second device of the sender user, wherein the computer implemented method further comprises, before step B, the following step:
H. displaying an identification code on said display of said first device of the sender user, and acquiring said identification code through said camera of said second device of the sender user to establish a connection on an encrypted communication channel between said first device of the sender user and said second device of the sender user,
wherein, in step B, said at least one digital content is transmitted from said first device of the sender user to said second device of the sender user.

9. A system of digital contents exchange configured to exchange digital contents among a plurality of users registered in a sharing association, wherein each user of said sharing association is associated to at least one device provided with one or more processing units and with one or more acquiring devices configured to acquire at least one biometric trait, wherein said at least one device of each user of said sharing association is configured to execute a computer implemented method of exchanging digital contents among a plurality of users registered in a sharing association, wherein said method comprises the following steps:
A. on said at least one device of each user of said sharing association, associating: a personal univocal code of the user under consideration generated on said at least one device of the user under consideration, wherein said personal univocal code of the user under consideration depends on one or more biometric features of identification of the user under consideration deriving from at least one biometric trait of the user under consideration acquired by said one or more acquiring devices, and a public key and a private key of a asymmetric cryptography algorithm corresponding to the user under consideration, wherein the public keys of all the users of said sharing association are accessible by or stored in said at least one device of each user of said sharing association;
B. on at least one device of a sender user of said sharing association, selecting at least one digital content that forms a transmission payload and further selecting one or more recipient users of said sharing association with whom to share said transmission payload;
C. on said at least one device of the sender user, encrypting said at least one digital content using as a cryptographic key said personal univocal code of the sender user, obtaining an encrypted payload;
D. on said at least one device of the sender user, for each one of said one or more recipient users, encoding said personal univocal code of the sender user through said asymmetric cryptography algorithm by means of said public key of the recipient user, obtaining a respective encoded personal univocal code of the sender user;
E. on said at least one device of the sender user, building an encrypted file comprising the encrypted payload and a matrix binary file, that includes said encoded personal univocal code of the sender user for each one of said one or more recipient users;
F. sending the encrypted file from said at least one device of the sender user to said at least one device of each one of said one or more recipient users; and
G. on said at least one device of each one of said one or more recipient users receiving the encrypted file,
a) decoding said encoded personal univocal code of the sender user through said asymmetric cryptography algorithm by means of said private key of the recipient user,
b) decrypting the encrypted payload using as a cryptographic key said personal univocal code of the sender user, obtaining said at least one digital content.

10. The system according to claim 9, further comprising at least one central processing device, optionally comprising or consisting in at least one server and/or at least one PC and/or at least one portable device, that is accessible, optionally via web, by a system administrator, and that records information related to one or more sharing associations of users and one or more logs of events related to transmissions of digital contents among users of a sharing association.

11. The system according to claim 9, further comprising at least one storage server, wherein said at least one device of each user of said sharing association is configured to execute the computer implemented method of exchanging digital contents among a plurality of users registered in a sharing association wherein, in step F, said method comprises sending the encrypted file from said at least one device of the sender user to said at least one device of each one of said one or more recipient users by means of an intermediate storage of the encrypted file on at least one storage server, thereby said at least one device of a sender user stores the encrypted file on said at least one storage server and said at least one device of each one of said one or more recipient users accesses said at least one storage server and downloads the encrypted file.

12. (canceled)

13. A set of one or more computer-readable media having stored thereon a set of one or more computer programs comprising instructions that, when executed by one or more processing units of a user's device, cause said user's device to execute a computer implemented method of exchanging digital contents among a plurality of users registered in a sharing association, wherein each user of said sharing association is associated to at least one device provided with one or more processing units and with one or more acquiring devices configured to acquire at least one biometric trait, wherein the computer implemented method comprises the following steps:
A. on said at least one device of each user of said sharing association, associating: a personal univocal code of the user under consideration generated on said at least one device of the user under consideration, wherein said personal univocal code of the user under consideration depends on one or more biometric features of identification of the user under consideration deriving from at least one biometric trait of the user under consideration acquired by said one or more acquiring devices, and a public key and a private key of a asymmetric cryptography algorithm corresponding to the user under consideration, wherein the public keys of all the users of said sharing association are accessible by or stored in said at least one device of each user of said sharing association;
B. on at least one device of a sender user of said sharing association, selecting at least one digital content that forms a transmission payload and further selecting one or more recipient users of said sharing association with whom to share said transmission payload;
C. on said at least one device of the sender user, encrypting said at least one digital content using as a cryptographic key said personal univocal code of the sender user, obtaining an encrypted payload;
D. on said at least one device of the sender user, for each one of said one or more recipient users, encoding said personal univocal code of the sender user through said asymmetric cryptography algorithm by means of said public key of the recipient user, obtaining a respective encoded personal univocal code of the sender user;
E. on said at least one device of the sender user, building an encrypted file comprising the encrypted payload and a matrix binary file, that includes said encoded personal univocal code of the sender user for each one of said one or more recipient users;
F. sending the encrypted file from said at least one device of the sender user to said at least one device of each one of said one or more recipient users; and
G. on said at least one device of each one of said one or more recipient users receiving the encrypted file,
a) decoding said encoded personal univocal code of the sender user through said asymmetric cryptography algorithm by means of said private key of the recipient user,
b) decrypting the encrypted payload using as a cryptographic key said personal univocal code of the sender user, obtaining said at least one digital content.

14. The computer implemented method according to claim 2, wherein the personal univocal code of each user of said sharing association is selected from the group comprising name, surname, email, fiscal code, VAT number, IMEI code, SSAID code and SIM ICCID code, and/or a PIN code.

15. The system according to claim 9, wherein said personal univocal code of each user of said sharing association further depends on one or more user's identification personal data.

16. The system according to claim 9, wherein said at least one biometric trait is selected from the group comprising a fingerprint, a face image, a voice print, an image of an iris, a tridimensional shape of a hand, and an image of a retina.

17. The system according to claim 9, wherein, in step F, sending the encrypted file from said at least one device of the sender user to said at least one device of each one of said one or more recipient users occurs by means of an intermediate storage of the encrypted file on at least one storage server, thereby said at least one device of a sender user stores the encrypted file on said at least one storage server and said at least one device of each one of said one or more recipient users accesses said at least one storage server and downloads the encrypted file.

18. The system according to claim 9, wherein, in step F, sending the encrypted file from said at least one device of the sender user is conditioned on a biometric recognition of the sender user.

19. The system according to claim 9, wherein said at least one device is selected from the group comprising a smartphone, a tablet, a laptop, and a PC.

20. The system according to claim 9, wherein, in step A, a respective asymmetric cryptography algorithm accessible from or stored in said at least one device of each user of said sharing association is associated to each user of said sharing association.

21. The system according to claim 9, wherein said at least one device of the sender user on which step B selects said at least one digital content is a first device of the sender user, provided with a display, and said at least one device of the sender user on which steps C, D, E, and F are executed is a second device of the sender user, provided with a camera, wherein the computer implemented method further comprises, before step B, the following step:
H. displaying an identification code on said display of said first device of the sender user and acquiring said identification code through said camera of said second device of the sender user to establish a connection on an encrypted communication channel between said first device of the sender user and said second device of the sender user,
wherein, in step B, said at least one digital content is transmitted from said first device of the sender user to said second device of the sender user.
